(19) United States
(12) Patent Application Publication
(10) Pub. No.: US 2016/0150778 A1
(43) Pub. Date: Jun. 2, 2016

(54) PLASTIC HAVING A BIOCIDAL SURFACE AND METHOD FOR PRODUCING SAID PLASTIC

(71) Applicant: JANSEN AG, Oberriet SG (CH)

(72) Inventors: Martin Winkler, Lachen (CH); Konstantin Siegmann, Greifensee (CH)

(21) Appl. No.: 14/786,092

(22) PCT Filed: Apr. 22, 2014
(86) PCT No.: PCT/IB2014/060900

§ 371 Date: Jan. 28, 2016

(30) Foreign Application Priority Data
Apr. 22, 2013 (EP) 13164793.5
Jul. 12, 2013 (EP) 13003529.8

(51) Int. Cl. A01N 33/12; A01N 25/10

(52) U.S. Cl. CPC A01N 33/12; A01N 25/10

(57) ABSTRACT

A polymeric material, in particular a polymeric material manufactured by polymerisation or polyaddition, for example polyolefins or polyurethanes, in particular polyethylene, with an antimicrobial surface.

The polymeric material contains a maximum of 0.1% by weight of fatty acid ester, a maximum of 0.1% by weight of superacid counter-ions and between 2.5% by weight and a maximum of 10% by weight, preferably a maximum of 5% by weight, of at least one compound (1) which brings about the antimicrobial action.

This compound (1) consists of at least one antimicrobially effective hydrophilic molecular group (2) and at least one molecular group (4) which causes physical anchoring of the compound (1) in the polymeric material (3).

The invention relates to a polymeric material, in particular a polymeric material manufactured by polymerisation or polyaddition, for example polyolefins or polyurethanes, in particular polyethylene, with an antimicrobial surface, as well as to a method for the manufacture of a polymeric material of this type.

Antibacterial or antibiotic coatings are known to be used in a great deal of equipment. Thus, in medical devices, combinations of silver-containing coatings/polymers are known. Silver ions, and also copper ions, are toxic to microorganisms. Unfortunately, however, coatings of that type are not all-purpose, as coatings of this type are consumed and slowly release metal ions, for example into water, and thus are unsuitable for contact with drinking water and pipelines or containers therefor.

One possibility of inhibiting biofilms is to generate a biocidal surface on which organisms cannot even become deposited. It is relatively difficult to provide polyethylene with a permanent biocidal surface. Polyethylene consists of long hydrocarbon chains which are highly unreactive. This means that chemical bonding is only possible using drastic measures, such as harsh UV light.

FIG. 1 shows the application of a biocidal polymer using suitable UV absorbers and UV light. The polymer is expensive to synthesize and the process is complicated.

The topic of polyethylene provided with an antibacterial action without the use of coatings, possibly by extrusion, forms the subject matter of the following publications, the disclosures of which are hereby incorporated by reference into the present application: WO2012/149591A1, CN102062264A, EP2436266A1, ES2370331A1, DE202010003123U, DE202008014092U, WO2007/045634A2, JPH06-1185562A, US2011/0233810A1, WO99/32157A2, JP2008-184451A, JP2007-063410A, JP2006-083331A, U.S. Pat. No. 6,852,776B2, WO2004/004456A1, JPH09-324070A, WO2012/089998A2, WO2006/081617A1, U.S. Pat. No. 6,790,910B1, U.S. Pat. No. 5,328,698A, U.S. Pat. No. 5,322,659A, US2011/0198764A1, US2007/0196605A1, KR20090045503A, DE202009006553U1, DE10022453A1 and CN101775170A. This is also the case for the disclosure of the features in the articles “Kunststoffe in Kontakt mit Trinkwasser” [Polymers in contact with drinking water] by Stefan Kotzsch et al. in AQUA & GAS No. 3/2013, pages 44 to 52, “Biofilme in Trinkwasserinstallationen” [Biofilms in drinking water installations] by Hans Peter Füchslin et al. in AQUA & GAS No. 3/2013, pages 54 to 59, and “Materialien in Kontakt mit Trinkwasser—Beurteilung nach DVGW und UBA” [Materials in contact with drinking water—assessment under the DVGW {German Technical and Scientific Association for Gas and Water} and UBA {German Federal Environmental Agency}] by Volker Meyer, in AQUA & GAS No. 3/2013, pages 60 to 62. Finally, this is also the case for the dissertation by Paul Kevin Barnes “The Synthesis and Practical Applications of Novel N-Halamine Biocides”, Auburn, Ala., 15 Dec. 2006. In the cited dissertation, “Quaternary ammonium salt grafted PE films” are mentioned: “grafted” means that the quats are chemically bonded to the surface, which makes these coatings complicated and expensive to manufacture. Thus, these coatings are particularly unsuitable for the manufacture of pipes for water.

Quaternary ammonium compounds, hereinafter abbreviated, as is customary, to “quats”, are organic ammonium compounds where all four valencies of a nitrogen atom are organically bonded. They are thus salts (ionic compounds) consisting of a cation and an anion.

With quats with at least one long alkyl group, in addition to surfactant properties, these are also known to have a disinfectant action. Thus, they are also biocides. This property of quats is exploited in many fields, for example in hospitals, in food preparation, in agriculture, in wood protection and in industry (clean room applications), as well as being a major ingredient in anti-algal-e substances (algicides) for swimming baths and pools. Recently, quats have also gained significance as ionic liquids and are also employed in water preparation as strongly basic ion exchangers for the production of demineralized water.

Use as a disinfectant is based on enriching quats in the cell membranes of living organisms, wherein the function of the cell membrane is compromised. This action also occurs when the quats are covalently bonded to a surface. This is also the principle behind using cationic surfactants in particular as disinfectants as well. The microbicidal action is only provided, however, when the chain length of the alkyl group bonded to the N atom is 8 to 18 C atoms.

Table 1 below shows an extract from a table with many possible combinations of quats on surfaces, as well as their effectiveness.

TABLE 1
Diagrammatic representation of some non-natural polycations,
chemically immobilized on various surfaces

| | | | Loading with |
|---|---|---|---|
| | | | microorganism, |
| | | | killing |
| Chemical unit | Surface | Microorganism | efficiency |
| 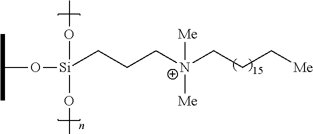 | 28 surfaces were employed | 26 microorganisms were investigated | 2 × 10²/cm², 95% killed in 30 min |
| 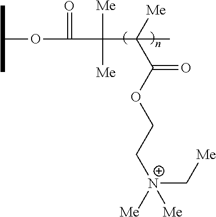 | Glass, paper | E.coli, B.subtilis | Between 1 × 10⁶ and 4 × 10⁷/cm², >99-100% killed in 1 h |
| 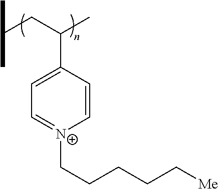 | Glass, polyethylene, polypropylene, nylon, polyethylene terephthalate | S.aureus, S.epidermidis, E.coli, P.aeruginosa | ND, between 94 and >99.8% killed in 2 min |
| 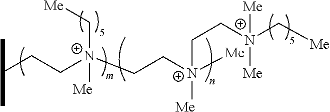 | Glass | S.aureus,E. coli | 1.5 × 10⁶/cm², 100% killed in 30 min |
| 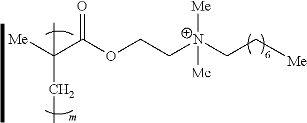 | Glass, wood | A.niger | 1.0 × 10³/cm², 100% killed in 4 days |

However, binding quats to polymer surfaces, in particular polyethylene surfaces, is problematic. Until now, quats have been processed using complex wet chemistry and/or UV light and/or with complicated plasma activation or expensive and complicated syntheses.

US 2011/0233810 A1 discloses a polymer composition (for example with Polyethylene) which is made antimicrobial using quats. However, a silane is bonded to the quat, which reacts as a reactive quat, i.e. with itself and/or with the matrix, to form covalent bonds. In this manner, the polymer composition does not “bleed”. Furthermore, the quat-silane is distributed homogeneously in the matrix.

WO00/36005 describes single screw extrusion of a quat with sufficient thermal stability and a polymer in order to produce an antistatic polymer. The basic polymer is a polyester or a similar material. Branched quats with heteroatoms in the side chains are used.

U.S. Pat. No. 3,591,563 discloses antistatic agents for polymers, including polyethylene. These agents are externally applied or compounded branched quats.

Quats as antistatic agents for polyolefin foams are described in U.S. Pat. No. 5,112,528. The quats in this case are mixed with fatty acid esters in order to make the mixture more strongly antistatic than in the individual compounds. The mixture is compounded at 150° C.

JP2006-083331A discloses the use of quats (for example dimethyl di-n-decyl ammonium) together with the counter-ion of a superacid (for example BF₄) as antimicrobial additives for polyethylene, as an example. The polyethylene is modified with an alpha, beta-unsaturated carbonic acid.

CN102062264A describes a three-layered polymeric water pipe the innermost layer of which is provided with a silver-free antimicrobial additive. This additive may be a quat; the middle layer may be polyethylene. However, there is no indication as to the mechanism for attaching the quats to the polymer.

The quat salts of JPH02-120342A with its C8 to C30 alkyl residues contain a hydrophobic counter-ion with seven or more carbon atoms. The quats with halide counter-ions described as comparative examples contain only short-chain (max C10) alkyl residues.

According to WO2008/132045, the quats are applied to the polymer by applying a coating to the finished part and curing, but not added directly to the melt. Furthermore, these are reactive quats with ethylenically unsaturated groups.

According to WO00/15897, quats are initially anchored (at high temperature) to a colorant and then supplied to the matrix polymer. Thus, an additive other than the quat is required. The polymer is immersed in and impregnated with an aqueous solution, rather than compounding and extruding a polymer/quat mixture.

Reactive quats polymerized and copolymerized with the matrix polymer are disclosed in US2006/0217515A1.

According to the disclosure of U.S. Pat. No. 5,104,649, quats are grafted onto polyethylene via sulphonamide groups, i.e. the quats are reactive quats and are covalently bonded to the polyethylene.

The use of bi-quats is described in the work “Bridge-linked bis-quaternary ammonium anti-microbial agents: relationship between cytotoxicity and anti-bacterial activity of 5,5′-[2,2′-(tetramethylenedicarbonyldioxy)-diethyl]bis(3-alkyl-4-methylthiazonium iodide)s” by Kazuto Ohkura et al. in Bioorganic & Medicinal Chemistry (2005) 2579-2587, wherein the bonding between the two nitrogen ions is not an alkyl chain, but a bond with integrated thioethers, amides or esters. Thus, the nitrogen ion s integrated into rings.

Thus, the aim of the present invention is to avoid the disadvantages of the prior art in providing a polymeric material with a surface which has biocidal properties. A further aim of the invention is to provide a method for the manufacture of a polymer of this type. No toxic chemicals or elution products should be present and the process is simple and economical. Preferably, the process for the production of articles from the polymer of the invention, in particular polymeric pipes, in particular for drinking water systems and medical apparatus, should be modified only minimally.

The aim is achieved by means of the features of the independent claim 1 as well as the independent claim 13. Advantageous further embodiments are set out in the figures and in the dependant patent claims.

The invention is characterized in that the polymeric material contains a maximum of 0.1% by weight of fatty acid ester, a maximum of 0.1% by weight of superacid counter-ions and between 2.5% by weight and a maximum of 10% by weight, preferably a maximum of 5% by weight, of at least one compound which brings about the antimicrobial action, which consists of at least one antimicrobially effective hydrophilic molecular group and at least one molecular group which causes physical anchoring of the compound in the polymeric material.

When used in a mixture of this type and in the polymeric material produced therefrom, these quats on the surface of the polymer have migrated, i.e. have segregated out, but are secured against elution by being physically anchored in the polymeric material.

Preferably, at least one compound from the quaternary ammonium compound group of substances with non-functional and/or unreactive end groups is selected as the compound with antimicrobial action.

Alternatively or additionally, at least one compound from the group of substances formed by compounds with at least one antiadhesively effective molecular group is selected as the compound with antimicrobial action, preferably from the perfluorinated hydrocarbon or silicone group of substances. In this manner, the surface energy of the polymer is adjusted to a value whereby biological material does not adhere to the polymer.

A preferred embodiment of all of the polymeric materials cited above is characterized in that at least one antiadhesively effective additive is covalently bonded to a compound from the quaternary ammonium compound group of substances.

The good miscibility of quats and the basic material of the polymer as a basic criterion for the physical anchoring of the quats is particularly well ensured when at least one of the molecular groups acting to anchor the compound with antimicrobial action has a high affinity for the basic material of the polymeric material. In particular, this should include a physico-chemical similarity and, for example, the long chain hydrocarbon residue should have the same nature as the polymeric basic material. As an example, a hydrophobic hydrocarbon residue might be provided for the polymer polyethylene, or one of the substituents on the nitrogen atom would have to be non-polar.

Advantageously in this regard, the compound with antimicrobial action comprises at least one preferably unbranched, long-chain residue.

Particularly preferably, quaternary ammonium compounds with at least two, preferably three hydrocarbon residues are used, wherein in particular, the elongated molecular chains or the long-chain hydrocarbon residue is at least a C17 alkyl, or these molecular groups may contain at least one C17 alkyl.

A particularly effective action is obtained with a polymeric material which, in accordance with a particularly advantageous embodiment of the invention, is characterized in that the antimicrobially active molecular group of the compound with antimicrobial or antiadhesive action or the antiadhesively effective molecular group protrudes out of the compound over the surface of the polymer and at least one other molecular group of the compound is anchored in the basic material of the polymeric material.

Preferably, at least one compound with antimicrobial action is a bifunctional, bridged quaternary ammonium compound which comprises two quaternary ammonium groups which are bridged by a common substituent. Entangled biquats of this type become particularly well anchored in the basic material of the polymer and thus can no longer be eluted. In addition, the density of the active groups can thus be increased.

A similar good action is obtained in a variation, in which at least one compound with antimicrobial action is a quaternary ammonium compound which additionally has an antiadhesively effective molecular group which is bridged with the quaternary ammonium compound by means of a common substituent.

Advantageously, the polymeric material is constituted such that the substituent encircles at least one long-chain molecule of the basic material of the polymeric material and thus is anchored in the polymeric material, wherein at least one, preferably both of the quaternary ammonium compounds or both the quaternary ammonium compound and the antiadhesively effective molecular group protrude over the surface of the polymeric material. This produces an optimized effectiveness of the quaternary ammonium compound, with its hydrocarbon residue being physically anchored in the polymer and its nitrogen group protruding over the surface of the polymer.

In order to accomplish the aim of the invention, the method for the manufacture of a polymer is characterized in that a polymer melt of a basic material is admixed with a mixture as defined in the paragraphs above, i.e. a mixture with a maximum of 0.1% by weight of fatty acid ester, a maximum of 0.1% by weight of superacid counter-ions and between 2.5% by weight and a maximum of 10% by weight, preferably a maximum of 5% by weight with respect to the weight of the polymer melt, of at least one compound causing an antimicrobial and/or antiadhesive action, said compound consisting of at least one antimicrobially or antiadhesively effective molecular group and at least one molecular group which physically anchors the compound in the polymeric material, and wherein the mixture of polymer melt and the mixture is compounded and the compounded mixture is then extruded.

In particular, it is advantageous when an antimicrobially active compound, preferably a quaternary ammonium compound with a high affinity for the basic material of the polymer, is mixed into the polymer melt. Because they are similar in nature, the quats and polymeric material mix together in an optimized manner and the quat is thus physically anchored in the polymer in an optimized manner.

In this manner, the quats in the extruded polymer melt migrate to the surface of the polymer in a manner such that their nitrogen group(s) protrudes/protrude over the surface of the polymer. Particularly with non-polar polymeric materials such as polyethylene, the positive charge of the nitrogen is incompatible with the non-polar polymer. Thus, the quat migrates to the surface and the charged group sticks out of the polymer.

Further advantages, features and details of the invention will become apparent from the following description which describes examples of the invention with reference to the accompanying drawings. In this regard, the features mentioned in the description and the claims may be essential to the invention either individually or in any combination.

The list of reference numerals forms part of the disclosure. The figures are clearly and comprehensively described. Identical reference numerals indicate identical components; reference numerals with different indices are used to indicate components with identical or similar functions.

In the drawings:

FIG. 1 shows the prior art, in particular the photochemical binding of a benzophenone derivative with biocidal molecules (quaternary ammonium salts, quats) onto a polyethylene surface,

FIG. 2 shows a section of a first embodiment of a polymer in accordance with the invention, as a diagrammatic representation,

FIG. 3 shows a preferred embodiment of an extruder,

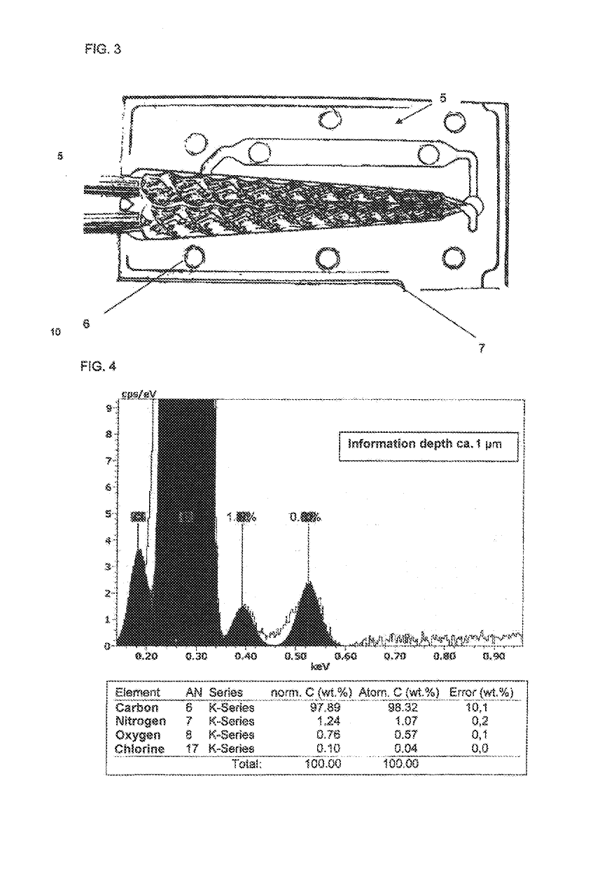

FIG. 4 shows the EDX spectrum of polyethylene with 10% quat admixture,

FIG. 5 shows the XPS spectrum of polyethylene with 10% quat admixture.

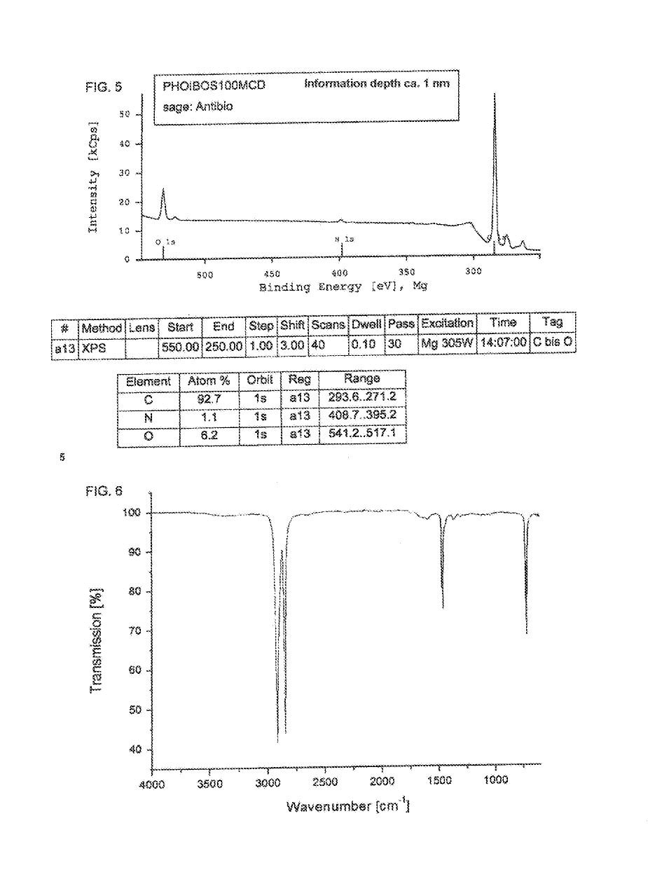

FIG. 6 shows the infrared spectrum of polyethylene,

FIG. 7 shows the infrared spectrum of polyethylene with 10% quat admixture,

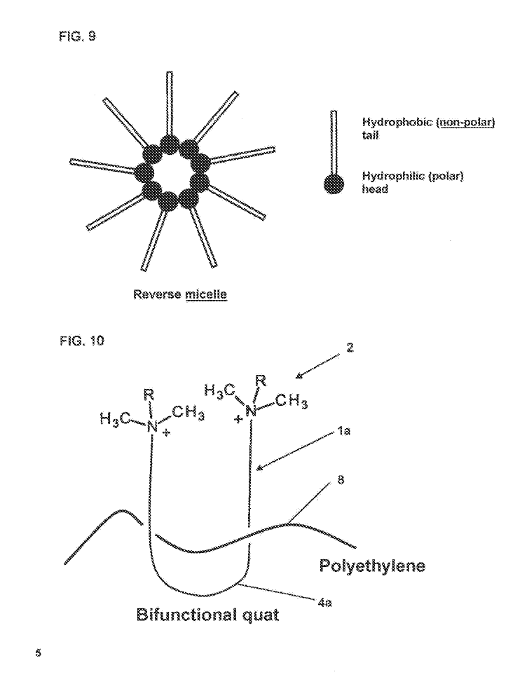

FIG. 8 shows the infrared spectrum of the admixed quat of FIG. 7,

FIG. 9 shows a micelle formed from quats,

FIG. 10 shows a bifunctional quat entangled with a polyethylene chain,

FIG. 11a shows an example of a bifunctional quat,

FIG. 11b shows a further example of a bifunctional quat,

FIG. 12a shows an example of an antiadhesive molecule, and

FIG. 12b shows a further example of a molecule of this type.

The invention will now be described with the aid of an example of the manufacture of an article formed from polyethylene with a biocidal surface. This may, for example, be a pipe for (drinking) water, but also other types of containers for liquids and/or gases. In principle, the invention may be used for a plurality of polymeric materials, in particular polymers produced by polymerization or polyaddition, for example polyolefins or polyurethanes, but in particular polyethylene. All of these materials may advantageously, as hereinafter described, be provided with an antimicrobially active surface.

At least one suitable quaternary ammonium compound (quat) 1 is added to the polyethylene melt. This process is known as compounding. During manufacture of the polymeric material in accordance with the invention, significant quantities of neither fatty acid esters nor of counter-ions to the superacids are necessary, so that the quantity of fatty acid esters is a maximum of 0.1% by weight and the quantity of superacid-counter-ions is a maximum of 0.1% by weight with respect to the polymeric material. The compound with antimicrobial action used is a quat 1 in an amount in the range 2.5% by weight and a maximum of 10% by weight with respect to the polymeric material. Preferably, the maximum content is 5% by weight.

In the context of the development of the present invention, the following successful tests were carried out with quats as shown in Table 2 below:

TABLE 2

| Code | Formula | Supplier | CAS | Price |
|---|---|---|---|---|
| A | 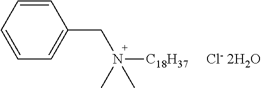 | TCI | 122-19-0 | 25 g/27 [symbol] |
| B | 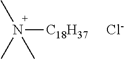 | Schrank 4 | 112-03-8 | |
| C | 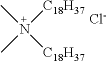 | TCI | 107-64-2 | 25 g/20 [symbol] |
| D | 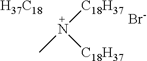 | Aldrich | 18262-86-7 | 5 g/172 CHF |
| E | 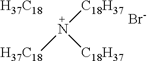 | Aldrich | 63462-99-7 | 5 g/213 CHF |

In the context of the manufacturing method of the invention, polyethylene is compounded with the measured quantity of at least one quat 1 with non-functional and/or unreactive end groups under appropriate conditions. In this regard, it should also be noted that the temperature of the melt must not become too high in order to avoid decomposition of the quaternary ammonium compounds 1. The basic material 3 of the polymer and the mixture mentioned above essentially without fatty acid esters, without superacid counter-ions and with a maximum of 10% by weight, preferably a maximum of 5% by weight with respect to the weight of the polymer melt, of at least one compound causing an antimicrobial and/or antiadhesive effect, for example a quat 1, is compounded and then extruded in order to manufacture the desired articles such as pipes, vessels etc. with an antimicrobial surface.

Because of the incompatibility of the quat 1, in particular its antimicrobially effective molecular group 2, with the polyethylene matrix 3, it migrates to the surface and thus can proceed to exert its biocidal action. This phenomenon is known as self-organization, since the quats 1 automatically extend their charge carriers 2 out of the polymeric material 3, because they are not miscible therewith. However, the long hydrocarbon chains 4 of the quats 1 have a suitably high affinity for the basic material 3 of the polymer and thus mix with the polyethylene, in particular when they have very similar constructions, i.e. consist of hydrocarbons, in accordance with the principle of similis similia solvuntur (like dissolves like).

Since the hydrocarbon chains 4 of the quat 1 in the polymer 3 stick and securely hold the quat 1, the hydrocarbon chains 4 are known as “anchors” and these polymer chains physically anchor the quat 1 in the polyethylene polymeric material 3. FIG. 2 diagrammatically shows how the long hydrocarbon portion 4 of the quaternary ammonium compound 1 acts as an anchor which fixes the molecules in the polymer 3 (however, the counter-ion to the positive nitrogen portion 2 is not shown). The charged head portions 2 protrude into the medium surrounding the polymer 3, for example into the interior of a (water) pipe, a vessel or the like, and act therein as a biocide.

The negatively charged counter-ion sits in the vicinity of the positive charge 2, for example outside the polyethylene matrix, i.e. outside the polymeric material 3, directly above its surface.

The “anchor” consists of the hydrocarbon chain 4 of the quat 1; this is said to be apolar. The hydrocarbon chain is covalently bonded to the quaternary nitrogen. Since it has the same nature as the polyethylene, it can interact with the hydrocarbon chains of the polyethylene, i.e. the polyethylene and the hydrocarbon chain from the quat 1 mutually attract. This mutual attraction is not a covalent bond, it is said to be a van der Waals force, which is weaker than an actual bond.

Preferably, the quat 1, which is always used as a monomer in accordance with the invention, is self-orientating, as explained above. In order to support this process, though, during mixing or even during further processing, orientation of the quats may be assisted by means of electrostatic forces or the like.

An extruder 5 as shown in FIG. 3 may be used, for example, for extrusion following mixing the quat 1 into the polymer melt in the manufacturing method discussed above. This comprises two synchronized screws 6 in a housing 7, wherein the axes of the screws 6 form an acute angle between them. The experiments in respect of the present invention were carried out with a device with a screw length of 11 cm and a volume of 7 mL, with screws that rotated at 50 revolutions per minute.

Experiments were carried out in which the additives shown in Table 2 were processed into a polyethylene melt in a concentration of 2.5%, 5% and 10% into polyethylene RT Dowlex 2388. The compounding conditions included 12 minutes of mixing at 210° C. Partial decomposition of the quat was observed during this step.

Part of the time, a strong violet coloration and a (“fishy”) smell of amines were observed, in particular with additives containing multiple methyl groups and at high concentrations. The probable decomposition mechanism is a Hofmann decomposition. The results can be summarized as follows:

| | 10% | 5% | 2.5% |
|---|---|---|---|
| A | + | + | + |
| B | ++ | + | 0 |
| C | + | 0 | 0 |
| D | 0 | − | − |
| E | − | − | − |

in which:
++ heavy discoloration
+ discoloration
0 weak discoloration
− hardly any discoloration

By selecting the concentration of the quat to be a maximum of 5%, its concentration is kept below the critical micellar concentration (CMC) for the formation of unwanted micelles. Micelles are small, spherical aggregates of the quat in the polyethylene. They are built up as follows: the charged “heads” of the quat are in the interior of the micelle and the apolar “tails” face into the polyethylene. Micelles are not wanted, as the quat does not migrate to the surface from them and is effectively lost.

FIG. 4 shows an EDX (energy dispersive X-ray spectroscopy) spectrum of polyethylene with a 10% admixture of additive C from the table above and FIG. 5 shows an XPS (X-ray photoelectron spectroscopy) spectrum of this same mixture.

FIG. 6 shows the infrared spectrum of polyethylene; FIG. 7 shows the infrared spectrum of polyethylene with an admixture of 10% of additive C from the above table, and FIG. 8 shows the infrared spectrum of this additive by itself.

All samples with 10% additive were analysed. The spectra of polyethylene, polyethylene with additive and additive alone were all similar. This is comprehensible from a chemical viewpoint, since no functional groups are present. It follows that infrared spectroscopy does not provide any information about the mixture and thus is not suitable for the analysis. On the other hand, X-ray spectroscopy, as can be seen in FIG. 4 and FIG. 5, for example, is very suitable for the analysis.

Furthermore, experiments were carried out to investigate the antimicrobial action of the material manufactured in accordance with the invention. In this regard, a particularly good action could be verified in compounds in which the compound with antimicrobial action was a quaternary ammonium compound 1 with at least two hydrocarbon residues 4, preferably three hydrocarbon residues 4. Preferably, the elongated molecular chain or the long-chain hydrocarbon residue 4 is or contains at least one C17 alkyl.

In the experiments, 5% by weight of a quat 1 was mixed with 95% by weight of polyethylene granulate and the mixture was extruded using a twin screw compounder such as that shown in FIG. 3, for example. The samples produced were extracted with water in order to remove non-anchored quats 1. Next, the material samples were exposed to S. aureus bacteria and their antimicrobial action was analysed. Next, a live/dead staining method was carried out using fluorescence microscopy. The remaining quat eluted from the samples was assayed using a Kirby-Bauer agar diffusion test.

The anchoring strength to the polyethylene surface of quats 1 with up to four C18 hydrocarbon chains 4 as the anchoring molecular group was investigated. While elution of antimicrobial substances could be observed with samples containing one or two hydrocarbon chains 4 on the quat 1, quats 1 with three or four such C18 alkyl chains 4 exhibited no growth inhibition of S. aureus in the region around the sample, confirming good anchoring of these two groups of quats 1 in the polymeric material 3.

For these well-anchored samples, an investigation was then carried out using the fluorescent microscope to examine the staining of bacteria on the sample surface with membrane-permeable DNA stain (syto 9, green) for bacteria which were still alive and membrane-impermeable DNA stain (propidium iodide, red) for dead bacteria. In this regard, quats 1 with three hydrocarbon chains 4, which were thus preferred, were observed to have an excellent microbial effect, while quats 1 with four “anchors” 4 exhibited a low such action.

FIG. 10 shows a further advantageous embodiment of a quaternary ammonium compound which here is in the form of a bifunctional, bridged quat la. Two head portions 2 are bonded together with the ammonium groups via a bridge 4a, wherein the bridge 4a is a pure hydrocarbon chain, such as in the example of the bifunctional quat with the empirical formula C₃₂H₇₀Br₂N₂ of FIG. 11a, or indeed a chain including other atoms such as in the example with the empirical formula C₅₂H₉₆N₂O₁₄S₂ of FIG. 11b.

In addition to the denser packing of functional groups, namely the charged head portions 2, better bonding with the polymer can be obtained with the bifunctional quat 1a. When the two head portions 2 or quat groups migrate to the surface of the polymer 3, they can then encircle a chain molecule 8 of the polymer, for example a polyethylene chain. In this manner, they are mechanically anchored (entangled) in the polymer and can no longer be eluted.

Bifunctional quats la may, for example, be synthesized as follows:

In order to manufacture the substance of FIG. 11a with the name dodecylmethylene-bis-(dimethyloctylammonium)-bromide C₃₂H₇₀Br₂N₂ (M=642.73), 100 mL of methanol and 17.3 g (110 mmol) of dimethyloctylamine were added to 16.4 g (50 mmol) of 1,12-dibromododecane and the solution was boiled for 20 hours under reflux. Next, the methanol was distilled off and the remaining oil was dissolved in 100 mL of water. The solution was washed with 100 mL of ethyl acetate and the water was distilled off. The remaining residue was dissolved in 100 mL of methylene chloride, dried with anhydrous sodium sulphate, filtered and then the methylene chloride was distilled off. A quantity of 29.97 g (91%) of a pale yellow oil was obtained which finally solidified after standing for approximately five days.

The structure could be verified by means of electrospray ionization-mass spectrometry; the presence of a few percent of methyl ether could also be detected, however. In order to avoid such problems, acetone instead of methanol could be used as the solvent.

The substance of FIG. 11b could, for example, be synthesized from poly(ethylene glycol)ditosylate, C₃₂H₅₀O₁₄S₂ (M=722.86) (PEG 400). A three-necked flask with a 50 mL dropping funnel, a nitrogen supply and a thermometer was filled with 51 g (0.128 mol) of PEG 400. 300 mL, of dry CHCl₃ was added and then 53.5 g (0.28 mol) of tosyl chloride was added. The solution was cooled to approximately 2° C. using an ice bath. Moisture was kept at bay by providing a slow supply of nitrogen throughout this period. Next, 45 mL of dry pyridine was slowly dropped into the solution, keeping the temperature from going above 4° C. The solution was kept cool for a further 2 hours and could then be warmed to ambient temperature, at which it was maintained for approximately 20 hours. Next, the solution was poured into a mixture of 200 g of ice and 80 mL of concentrated hydrochloric acid. After shaking, the phases were separated and the CHCl₃ phase was dried with anhydrous sodium sulphate. The CHCl₃ was then distilled off, whereupon 81.6 g (90%) of PEG ditosylate was obtained as an oil (cf: Organikum, 23^{rd} edition, p. 662).

A 250 mL flask was filled with 37.92 g (52.5 mmol) of PEG (400) ditosylate. Approximately 100 mL of acetone was added, followed by 16.5 g (approximately 21.6 mL or 104.9 mmol) of dimethyloctylamine. The mixture was heated under reflux for approximately 20 hours, whereupon the acetone was distilled off, giving α,ω-bis(dimethyloctylammonium)PEG(400) ditosylate (C₅₂H₉₆N₂O₁₄S₂, M=1037.46) as a brownish, viscous oil; electrospray ionization mass spectrometry showed that the structure was as shown in FIG. 11b (yield 100%). The oil was soluble in acetone, chloroform and water, but insoluble in ethyl acetate.

Specifically adjusting the surface tension is another separate approach to preventing contamination of the surface of the polymer. A suitable surface tension should prevent adhesion of cells. The next two approaches may also be combined.

On the one hand, a suitable surface tension can make adhesion of biomaterial more difficult or entirely impossible, and on the other hand, biofilm formation is prevented because of the biocidal action of the quat. Although strong binding between the quat and the cell walls or membranes of the cells initially results in film formation, cells killed by the quats can no longer adhere to the surface of the polymer and can be washed away, for example. A biofilm can thus no longer form on a biocidal surface.

In order to reduce adhesion of cells to the surface of the polymeric pipe, its surface energy should be optimized. Perfluorinated hydrocarbons or silicones are particularly suitable for this purpose. The antiadhesive properties of these two classes of compounds are generally known and are employed for many applications. The problem arises of fixing these agents to the surface of the polyethylene used for the pipes. To this end, the antiadhesively effective compounds are provided with an “anchor”, which should fix it in the polyethylene. The anchor is a long hydrocarbon chain which is miscible with the Polyethylene and which fixes the molecule in the polymer by physical interaction. A further variation may also be envisaged, wherein at least one antiadhesively effective additive is covalently bonded to a compound from the quaternary ammonium compound group of substances.

Diagrammatically, the antiadhesively effective polymer additive appears as follows:

(hydrocarbon chain)-(perfluorinated alkane)

(hydrocarbon chain)-(silicone)-(hydrocarbon chain)

The antiadhesively effective molecule may be provided with an anchor at one or both ends. These copolymers are compounded with polyethylene. Because of the incompatibility of the silicone or fluorinated chain with the polyethylene matrix, the copolymers segregate at the surface where they exert their antiadhesive action, and the anchor chain fixes the molecule in the polymer. As an example, the compounds illustrated in FIGS. 12a and 12b were synthesized.

The compound of FIG. 12a can be obtained by esterification of stearic acid with the fluorinated alcohol, while the second molecule of FIG. 12b can be produced by hydrosilylation of two octadecene molecules with a hydride-terminated polydimethylsiloxane, catalysed by platinum.

While in the embodiment of the invention discussed above at least one compound with antimicrobial action is a bifunctional bridged quaternary ammonium compound 1a which comprises two quaternary ammonium groups 2 which are bridged by a common substituent 8, alternatively, a quat 1 may additionally exhibit an antiadhesively effective molecular group on the common bridging substituents. In each case, the substituent encircles at least one long-chain molecule 8 of the basic material of the polymeric material 3 and thus anchors the microbial and/or antiadhesively effective molecule in the polymeric material 3. In this manner, both the quaternary ammonium group 2 and also the antiadhesively effective molecular group preferably protrude over the surface of the polymeric material 3.

Although the present invention preferably employs quaternary ammonium compounds (quats), other compounds which have a long-chain end and a positively charged head may also be employed. Nitrogen in fact possesses only three bonding positions. However, when it is forced to take up a fourth bond, i.e. to make it quaternary nitrogen, it acquires a positive charge. Instead of nitrogen, other positively charged quaternary atoms may be used such as phosphonium and arsenium compounds, for example. Negatively charged groups with long hydrocarbon chains such as sulphonic acids might also be considered.

In addition to the aforementioned polyethylene which is completely apolar (i.e. no ions or dipoles, just electroneutral C—C and C—H bonds), other polymers with electroneutral components may also be employed. The quats 1 segregate out from all of these materials.

A polyethylene blend or similar blend primarily does not react at all with the quats 1 and the anchors 4. The anchors 4 are only bonded to the respective polymer material 3 via Van der Waals forces. However, because the anchors 4 are so long, the weak Van der Waals forces add together and fix them in the polyethylene.

The concentration of the admixed quaternary ammonium compounds 1, as is the same for all other similar compounds in other polymers, results from a trade-off between two effects. On the one hand, these compounds are expensive and may also lead to deterioration of the mechanical properties. On the other hand, the aim is to obtain an optimal biocidal action, and so naturally the surface of the polymer, for example the interior of pipes for conveying fluids, in particular pipes for the transport of water, must be covered with the biocidally active portions of the quats as densely as possible. Thus, current suitable maximum concentrations for the quats have been determined to be 10%, advantageously a maximum of 5%.

The biocidally active compounds may also be introduced into resin or lacquer type substances which can be applied to the surfaces of choice, for example by spraying or blowing into pipes.

The invention thus also encompasses a substance formed from a mixture of polymer with quats for the preparation of a (hydrophilic polymeric) surface with a biocidal action and/or a germ-repellent (biofilm formation-preventing) action. The polymer used is primarily polyethylene, and alternatively also polyurethane or Teflon. The use of quats with synthetic resins with the consistency of a lacquer may also be envisaged.

These mixtures may be used on polymeric surfaces in the enhanced hygiene field, such as the innermost layer of a pipe (in particular water pipes), as the water-facing layers in a valve, as the innermost layer of water containers, in particular hot water tanks, as the innermost layer of central heating units, underfloor heating and the like, as the innermost layer of sewage pipes or indeed as the innermost layer of swimming pool linings or pond linings.

Finally, we provide some further explanations of terms used in the above text:

Quats consist of two segments: a hydrophilic, polyethylene-repelling ionic portion, known as the head. On the other side is the hydrocarbon chain, which is hydrophobic, and thus polyethylene-attracting and apolar and is known as the tail. The differences between the head and tail are responsible for the various effects, such as micelle formation (see FIG. 9) and surface segregation, for example.

In polyethylene, the heads of the quats readily clump together so that they do not have to come into contact with the unwanted polyethylene. At the surface of the polyethylene, they stretch out the heads, into the vacuum it could be said, and thus escape contact with the polyethylene. Regarding the counter-charge, i.e. the counter-ion, namely the chloride or bromide, a distinction must be made depending on whether the surface is in contact with air or with water. In air, the negatively charged counter-ion will stay as close as possible to the positively charged nitrogen. Charge separation is energetically unfavourable, and forming electrical fields consumes a lot of energy. Thus, the surface does not become charged. In water however, which is a dielectric, the counter-ions can move to a certain extent because the water dipole can stabilize the charges. High electrical fields never occur, however, as they would be immediately compensated for by ion transport. A certain fluctuation of the counter-ions thus occurs in water but not in air.

### LIST OF REFERENCE NUMERALS

1 quaternary ammonium compound (quat)

1a bifunctional quat

2 positive charge carrier of the quat

3 polymeric material

4 carbon chain of quat

4a bridge of bifunctional quat

5 extruder

6 screw of extruder

7 extruder housing

8 polymeric chain molecule

1-13. (canceled)

14. Plastic material, made in particular by polymerization or polyaddition plastics, for example, polyolefins or polyurethanes, in particular polyethylene, marked with an antimicrobial surface, characterized in that the plastic material more than 0.1 weight-% fatty acid ester, a maximum of 0.1 weight-% superacid counterion and between 2.5 weight -% and at most 10 weight-%, preferably at most 5 weight-%, at least one of the antimicrobial effect of causing the compound (1), consisting of at least one antimicrobially active hydrophilic molecular group (2) and at least one of a physical anchorage of the compound (1) in the plastic material (3) effecting molecular group (4).

15. Plastic material according to claim 14, characterized in that the compound (1) is selected at least one compound from the substance group of quaternary ammonium compounds with non-functional and/or non-reactive terminal groups with antimicrobial activity.

16. plastic material according to claim 14, characterized in that has been selected as a compound having antimicrobial activity, at least one compound from the substance group of compounds with at least one anti-adhesive active molecule group, preferably from the group of substances of perfluorocarbons or silicones

17. Plastic material according to claim 14, characterized in that at least one anti-adhesive effective additively covalently to a compound (1) is attached from the substance group of quaternary ammonium compounds.

18. The plastic material according to claim 14, characterized in that at least one of the anchoring of the compound (1) with antimicrobial activity effecting molecular groups (4) a high affinity to the base material (3) of the plastic material.

19. Plastic material according to claim 18, characterized in that the compound (1) with antimicrobial activity comprising at least a preferably unbranched, long-chain hydrocarbon radical (4).

20. plastic material according to claim 15, characterized in that the compound (1) with antimicrobial activity, a quaternary ammonium compound having at least two, preferably three hydrocarbon groups (4).

21. Plastic material according to claim 19, characterized in that the elongated molecular chain or long-chain hydrocarbon group (4) is or contains at least one C17-alkyl.

22. Plastic material according to claim 14, characterized in that the antimicrobially effective molecular group (2) or the anti-adhesive active molecule group of the compound (1) with anti-microbial or anti-adhesive effect protrudes over the surface of the plastic material (3) and at least one other molecular group (4) of the compound (1) in the base material (3) of the plastic material is anchored.

23. Plastic material according to claim 14, characterized in that at least one compound having antimicrobial activity is a bifunctional, bridged quaternary ammonium compound (1a), having two quaternary ammonium groups, (2), which by a common substituent (4a) are bridged.

24. Plastic material according to claim 14, characterized in that at least one compound with antimicrobial activity is a quaternary ammonium compound, which additionally comprises an anti-adhesive active molecule group bridging with the quaternary ammonium compound through a common substituents is.

25. Plastic material according to claim 23, characterized in that the substituent (4a) has at least a long chain molecule (8) of the base material (3) of the plastic material surrounds and is anchored so that the plastic material (3), wherein at least one, preferably both quaternary ammonium compounds (2) or both of the quaternary ammonium compound and the anti-adhesive active molecule group on the surface of the plastic material (3) protrude.

26. A process for the manufacture of a plastic material, in particular by polymerization or polyaddition, for example a polyolefin or polyurethane, in particular polyethylene, with antimicrobial surface, characterized in that a plastic melt of a base material is a mixture as in claim 14 admixed, that is, a mixture with a maximum of 0.1 weight-% fatty acid ester, a maximum of 0.1 weight-% superacid counterions and between 2.5 weight-% and at most 10 weight-%, preferably at most 5 weight-%, based on the weight of the plastic melt, at least one antimicrobial and/or anti-adhesive effect inducing compound which compound is composed of at least one anti-microbial or anti-adhesively active molecule group and at least one physical anchoring of the compound in the plastic material causing molecular group, and then the mixture of molten plastic and the mixture compounded and compounded mixture is then extruded.
